(19) United States
(12) Patent Application Publication
(10) Pub. No.: US 2020/0208393 A1
(43) Pub. Date: Jul. 2, 2020

(54) Air jet type pipeline decontamination machine

(71) Applicant: Delan Fang, Guangzhou City (CN)

(72) Inventor: Delan Fang, Guangzhou City (CN)

(21) Appl. No.: 16/815,029

(22) Filed: Mar. 11, 2020

(30) Foreign Application Priority Data
Nov. 15, 2019 (CN) 201911121772X

(51) Int. Cl. E03F 9/00; B08B 1/00; B08B 5/02; B08B 9/032; B08B 9/043

(52) U.S. Cl. CPC E03F 9/002; B08B 1/005; B08B 9/0436; B08B 9/0328; B08B 5/02

(57) ABSTRACT

The invention relates to the field of jet propulsion application, in particular to a jet propulsion pipeline decontamination machine, which includes a fuselage and a fixing frame provided on the left side of the fuselage. In the gear lever fixedly connected to the fuselage, four guide grooves opening outward are symmetrically distributed in the center of the end wall of the fixed frame, and left and right symmetrical moving blocks are slidably arranged in the guide groove. The moving block is provided with left and right threaded holes with reverse threads passing through the left and right, and the threaded holes are internally connected with threaded rods. The jet propelled pipeline decontamination machine provided by the present invention can realize the sludge in the pipeline. For cleaning, the equipment uses jet propelling equipment to drive the scraper to the depth of the pipeline. When it moves to the maximum limit, it drives the scraper to abut against the pipe wall, and then pulls the scraper to the outside of the pipe through the wire drawing device, thereby contaminating the inner wall of the pipe Mud scraping, the device of the invention is completely scraped, and the scraping force is large, which is more efficient.

### CROSS-REFERENCES TO RELATED APPLICATIONS

The present application claims priority from Chinese application No. 201911121772X filed on Sep. 19, 2019 which is hereby incorporated by reference in its entirety.

### TECHNICAL FIELD

The invention relates to the field of jet propulsion application, in particular to a jet propulsion pipeline decontamination machine.

### BACKGROUND OF THE INVENTION

When the urban sewage pipeline is blocked, the traditional method of cleaning requires manual cleaning, which is not only very dangerous, but also has poor cleaning effect. The traditional method of cleaning has low cleaning efficiency and cannot effectively solve the sludge removal of the pipeline. Affecting the sewage discharge capacity of urban pipelines, it is necessary to set up a jet propulsion pipeline decontamination machine to improve the above problems.

### BRIEF SUMMARY OF THE INVENTION

The object of the present invention is to provide a jet propulsion pipeline decontamination machine, which can overcome the above-mentioned defects of the prior art, thereby improving the practicability of the equipment.

The technical solution adopted by the present invention to solve its technical problems is: a jet propulsion pipeline decontamination machine of the present invention includes a fuselage and a fixing frame provided on the left side of the fuselage, and the center on the end wall of the fuselage The levers fixedly connected to the fuselage are symmetrically distributed, and four guide grooves with outward openings are symmetrically distributed in the center of the end wall of the fixed frame. The left and right symmetrical moving blocks can be slidably arranged in the guide grooves. The left and right two moving blocks are provided with left and right threaded holes with reverse threads penetrating through the left and right, the threaded holes are internally connected with threaded rods, and the moving block is hinged on the end wall away from the center of the fixed frame. A hinged rod is connected, and the ends of the left and right hinged rods are hingedly connected to a support block slidingly arranged in the guide groove. The support block is provided with rotatable rollers symmetrically on the left and right sides, and the right side of the guide groove The rotation device provided in the end wall drives the threaded rod to rotate, which can drive the roller to move to the inner wall of the pipeline to be cleaned, thereby supporting the fixed frame in the pipeline, and the jet propeller provided in the fixed frame sprays The exhaust cavity provided in the fixed frame is ejected to drive the fixed frame to move quickly in the pipeline. A sliding cavity is provided in the fuselage, and a sliding block is slidably disposed in the sliding cavity. A first spring is provided between the sliding block and the left end wall of the sliding cavity, and a wire drawing device is provided in the sliding block. The wire drawing device can rotate the winding wheel provided in the sliding block to orbit. A pull wire is wound around the outer surface of the reel to pull the fixing frame out of the pipeline. The center of the end wall of the fixing frame is symmetrically distributed with four fan-shaped slots opening outward, and the fan-shaped slot and its right end wall A scraping device is provided inside, and the fixed frame triggers the pulling wire to trigger the fan-shaped scraper provided in the scraping device to move out of the fan-shaped groove and connect with the inner wall of the pipe to be decontaminated. The wire drawing device drives the fixed frame to scrape the sludge from the inner wall of the pipe when it is removed from the pipe. A left-side end wall of the sliding cavity is provided with a moving slot that opens to the right. The power device provided in the moving slot can be driven in a time-sharing manner. The rotation Counter means and said cable.

Further, the rotating device includes a rotating cavity provided in the fixing frame and a rightward opening groove provided in a right end wall of the fixing frame, and the right end of the threaded rod projects into the rotating cavity. A first gear is fixedly provided at the end, and a spline shaft is rotatably provided between the rotating cavity and the groove, and a spline shaft is fixedly provided at the end of the spline shaft in the rotating cavity to mesh with the first gear. Second gear.

Further, the wire drawing device includes a transmission cavity provided in the sliding block, four winding cavities are symmetrically disposed in the center of the end wall of the transmission cavity, and a rotation cavity is provided between the transmission cavity and the winding cavity. A first rotating shaft, the end of the first rotating shaft in the winding cavity is fixedly connected to the winding wheel, and the first rotating shaft end in the transmission cavity is fixedly provided with a first bevel gear, and the transmission cavity A second rotating shaft is rotatably disposed in the left end wall, and a second bevel gear meshing with the first bevel gear is fixedly disposed at the end of the second rotating shaft in the transmission cavity. A spline sleeve is fixedly arranged through the left end wall and the end of the sliding block.

Further, the scraping device includes a first sliding hole opened to the left in the right end wall of the fan-shaped groove, and the first sliding hole is slidably provided with the right end of the fan-shaped scraper. A first sliding rod matched with a slot provided in the wall, a second spring is provided between the first sliding rod and the right end wall of the first sliding hole, and the pull wire penetrates away from the end of the side of the reel The end of the fixing frame is fixedly connected to the right end wall of the first sliding rod, and a third spring is provided between the fan-shaped scraper and the fan-shaped groove end wall.

Further, the power device includes a fixed block slidably disposed in the moving groove, a drive motor is fixedly disposed in the fixed block, and a left and right guide sliding hole is provided in the left end wall of the sliding cavity. A first rack fixedly connected to the sliding block is slidably disposed in the guide sliding hole, and a gear cavity is provided between the guide sliding hole and the moving groove, and the gear cavity is rotatable. A third gear is engaged with the first rack and a second rack provided on the upper and lower end walls of the fixed block. A third shaft is rotatably provided in the left end wall of the moving groove. Spline holes are symmetrically arranged in the left and right end walls of the third rotating shaft, and the left end of the drive motor output shaft extends into the spline hole on the right side and is splined to it. A key hole is splined to the spline shaft. A second sliding hole opening to the left is provided in the left end wall of the fuselage, and a second sliding rod is slidably provided in the second sliding hole. The second sliding rod is disposed between the second sliding rod and the end wall of the second sliding hole. A reset device that drives the second slide rod to reset after displacement. A third sliding hole opposite to the opening is symmetrically arranged in the upper and lower end walls of the sliding cavity, and the third sliding hole is slidably provided with the sliding block. A third sliding rod matched with a locking groove provided symmetrically in the upper and lower end walls, a fourth spring is disposed between the third sliding rod and the end wall of the third sliding hole, and left and right through holes are disposed in the third sliding rod. Oblique holes.

The beneficial effects of the present invention: The jet propelling pipeline decontamination machine provided by the present invention can realize the removal of sludge in the pipeline. The equipment uses the jet propelling equipment to drive the scraper to the depth of the pipeline and moves to the maximum limit. When the scraper is brought into contact with the pipe wall, and then the scraper is pulled out of the pipe by the wire drawing device, thereby scraping the sludge from the inner wall of the pipe, the device of the invention is thoroughly scraped, and the scraping force is large and more efficient.

### BRIEF DESCRIPTION OF THE DRAWINGS

In order to more clearly explain the embodiments of the invention or the technical solutions in the prior art, the drawings used in the description of the embodiments or the prior art are briefly introduced below. Obviously, the drawings in the following description are merely For some embodiments of the invention, for those of ordinary skill in the art, other drawings can be obtained based on these drawings without paying creative labor.

The invention is further described below with reference to the drawings and embodiments.

FIG. 1 is a schematic diagram of the overall structure of a jet propulsion pipeline decontamination machine according to the present invention.

FIG. 2 is an enlarged structural diagram of A in FIG. 1.

FIG. 3 is a schematic structural diagram of B-B in FIG. 1.

FIG. 4 is a left side view of FIG. 1.

### DETAILED DESCRIPTION OF THE INVENTION

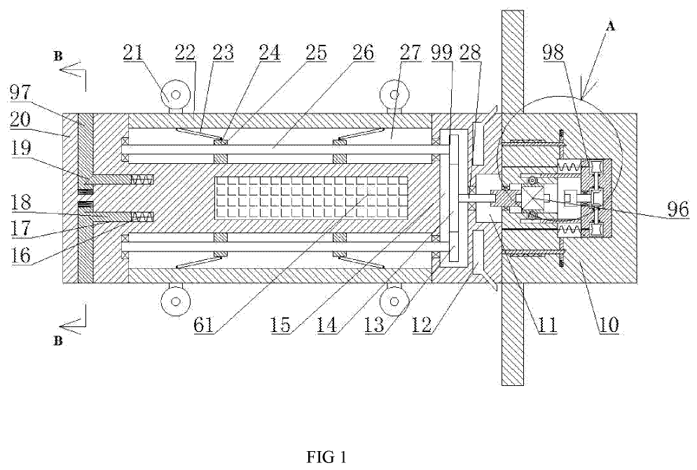

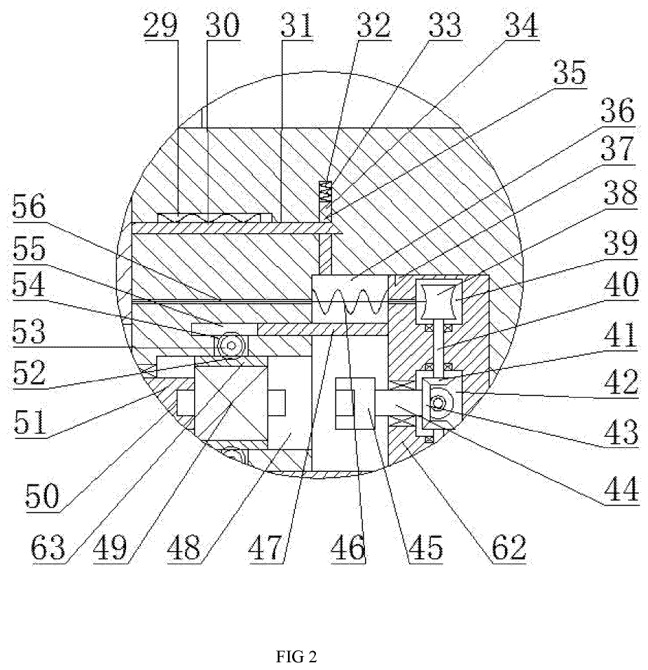

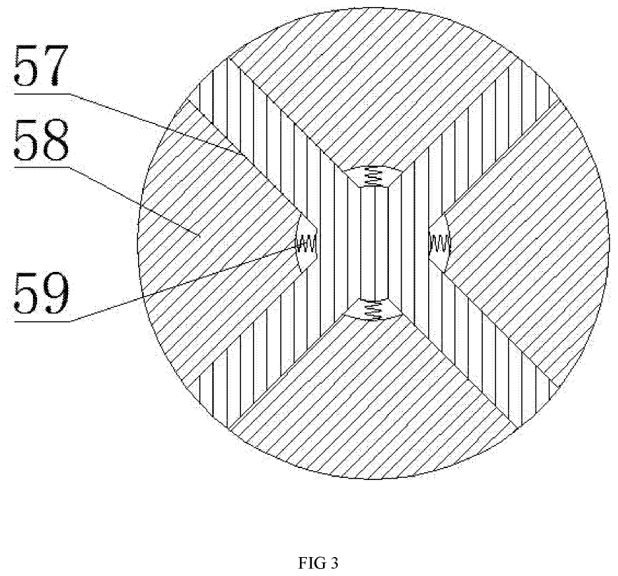

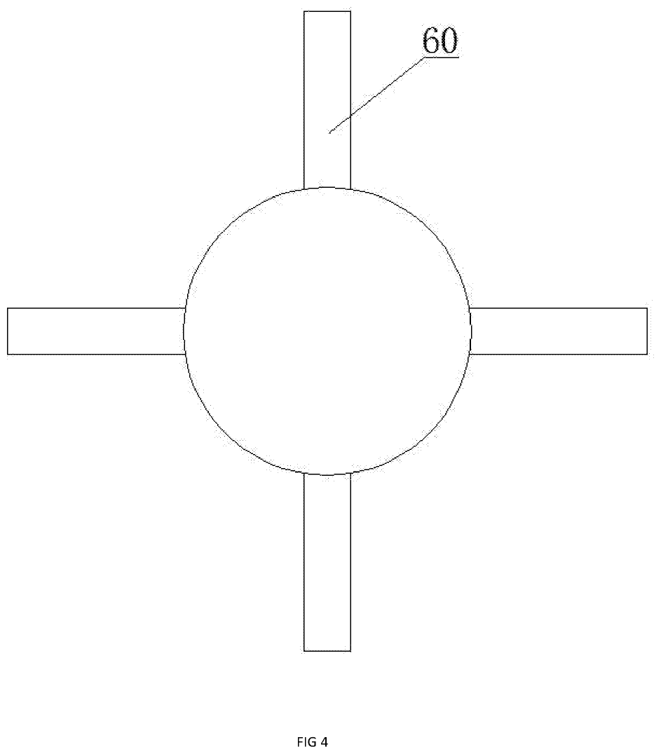

The present invention will be described in detail below with reference to FIGS. 1-4. For convenience of description, the orientation described below is defined as follows: the up-down, left-right, front-back direction described below is consistent with the up-down, left-right, front-back direction of the projection relationship of FIG. 1 itself.

A jet propulsion pipeline decontamination machine described in conjunction with FIGS. 1-4 includes a fuselage 10 and a fixing frame 20 provided on the left side of the fuselage 10. The center of the end wall of the fuselage 10 is symmetrically distributed. A gear lever 60 fixedly connected to the fuselage 10, four guide grooves 27 opening outward are symmetrically distributed in the center of the end wall of the fixing frame 20, and the left and right symmetrical grooves are slidably arranged in the guide groove 27. The moving block 24 is provided with a left and right threaded hole 25 with reverse threads passing through the left and right moving blocks 24. The threaded hole 25 is internally connected with a threaded rod 26, and the moving block 24 is far from the fixed A hinge rod 23 is hingedly connected to the end wall on the center side of the frame 20, and the ends of the two left and right hinged rods 23 are hingedly connected to the support blocks 22 slidably disposed in the guide groove 27, and the left and right sides of the support block 22 are symmetrical. A rotatable roller 21 is provided, and a rotating device 99 provided in the right end wall of the guide groove 27 drives the threaded rod 26 to rotate, so that the roller 21 can be moved toward the inner wall of the pipe to be cleaned, thereby moving the roller 21 The fixed frame 20 is supported in the pipeline. The air-injector 61 is ejected through the exhaust cavity 12 provided in the fixing frame 20, thereby driving the fixing frame 20 to move quickly in the pipeline. A sliding cavity 36 is provided in the fuselage 10, and the sliding cavity 36 A sliding block 62 is slidably provided. A first spring 46 is provided between the sliding block 62 and the left end wall of the sliding cavity 36. A wire drawing device 98 is provided in the sliding block 62. The wire drawing device 98 can The reel 38 provided in the sliding block 62 rotates, so that the pull wire 56 wound around the outer surface of the reel 38 is pulled, so as to pull the fixing frame 20 out of the pipeline, and the end wall of the fixing frame 20 Four fan-shaped grooves 57 opening outward are symmetrically distributed in the center. A scraping device 97 is provided in the fan-shaped groove 57 and the right end wall. The fixing frame 20 triggers the scraping when the pulling wire 56 is straightened. The fan-shaped scraper 58 provided in the device 97 moves out of the fan-shaped groove 57 and is connected to the inner wall of the pipe to be decontaminated, so that when the wire drawing device 98 drives the fixing frame 20 to move out of the pipe, the sludge on the inner wall of the pipe is scraped off. The left end wall of the sliding cavity 36 is provided with a moving slot 48 opening to the right Power means 48 provided in the groove 96 can be the mobile device 99 and a time division driving the rotating device 98 to the wire.

Advantageously, the rotating device 99 includes a rotating cavity 15 provided in the fixing frame 20 and a rightward opening groove 11 provided in a right end wall of the fixing frame 20, and the right end of the threaded rod 26 extends A first gear 13 is fixedly inserted into the rotation cavity 15 at the end, and a spline shaft 28 is rotatably provided between the rotation cavity 15 and the groove 11, and the spline shaft in the rotation cavity 15 A second gear 14 meshed with the first gear 13 is fixedly provided at the end of 28.

Advantageously, the wire drawing device 98 includes a transmission cavity 42 provided in the sliding block 62, and four winding cavities 39 are symmetrically disposed in the center of the end wall of the transmission cavity 42. The transmission cavity 42 and the winding A first rotating shaft 40 is rotatably provided between the cavities 39. The end of the first rotating shaft 40 in the winding cavity 39 is fixedly connected to the winding wheel 38, and the first rotating shaft 40 in the transmission cavity 42 is fixed. A first bevel gear 41 is fixedly disposed at the end, a second rotating shaft 44 is rotatably disposed in the left end wall of the transmission cavity 42, and a second rotating shaft 44 is fixedly disposed at the end with the second rotating shaft 44 in the transmission cavity 42. A second bevel gear 43 meshed with the first bevel gear 41, a left side of the second rotating shaft 44 penetrates a left end wall of the sliding block 62, and a spline sleeve 45 is fixedly disposed at the end.

Advantageously, the scraping device 97 includes a first sliding hole 17 opened to the left in the end wall on the right side of the fan-shaped groove 57, and the first sliding hole 17 is slidably provided with the fan-shaped scraping. A first sliding rod 18 cooperated with a clamping slot 19 provided in the right end wall of the plate 58, and a second spring 16 is disposed between the first sliding rod 18 and the right end wall of the first sliding hole 17. 56 The end of the side far from the reel 38 penetrates the end of the fixing frame 20 and is fixedly connected to the right end wall of the first sliding rod 18, and a fan-shaped scraper 58 and an end wall of the fan-shaped groove 57 are provided. Third spring 59.

Beneficially, the power device 96 includes a fixed block 63 slidably disposed in the moving groove 48, a drive motor 49 is fixedly disposed in the fixed block 63, and an opening is provided in the left end wall of the sliding cavity 36. A right sliding guide hole 55 is provided with a first rack 47 fixedly connected to the sliding block 62 in the sliding guide hole 55. The sliding guide hole 55 communicates with the moving groove 48. A gear cavity 54 is provided, and a third gear 53 meshed with the first rack 47 and the second rack 52 provided on the upper and lower end walls of the fixing block 63 is rotatably provided in the gear cavity 54. A third rotating shaft 51 is rotatably provided in the left end wall of the moving slot 48. Spline holes 50 are symmetrically provided in the left and right end walls of the third rotating shaft 51. The left end of the output shaft of the driving motor 49 extends Into the spline hole 50 on the right side and spline connection with it, the spline hole 50 on the left side is splined with the spline shaft 28, and the left end wall of the fuselage 10 is provided with A second sliding hole 31 is opened to the left, and a second sliding rod 30 is slidably disposed in the second sliding hole 31. The second sliding rod 30 and A resetting device 29 is provided between the end walls of the second sliding hole 31 to drive the second sliding rod 30 to reset after the second sliding rod 30 is displaced. The upper and lower end walls of the sliding cavity 36 are symmetrically provided with opposite openings. The third sliding hole 32 is provided with a third sliding rod 34 slidably fitted with a locking groove 37 symmetrically provided in the upper and lower end walls of the sliding block 62. The third sliding rod 34 is slidably provided in the third sliding hole 32. A fourth spring 33 is provided between the third sliding hole 32 and an end wall of the third sliding hole 32, and an inclined hole 35 is formed in the third sliding rod 34.

The fixed connection method described in this embodiment includes, but is not limited to, methods such as bolt fixing and welding.

As shown in FIGS. 1-4, when the device of the present invention is in an initial state, the reset device 29 is in a stretched state, the fourth spring 33 is in a compressed state, and the third spring 59 is in a compressed state.

The sequence of mechanical actions of the entire device:

The fixing frame 20 is placed in a pipe for removing sludge. At this time, the driving motor 49 is started to drive the third rotating shaft 51 to rotate, thereby driving the spline shaft 28 to rotate, thereby driving the second gear. 14 turns, thereby driving the first gear 13 to rotate, thereby driving the threaded rod 26 to rotate, thereby driving the left and right two moving blocks 24 to move back and to the left and right, thereby pushing the supporting block 22 to move, thereby The roller 21 is pushed into abutment with the tube wall, and the jet thruster 61 is started at this time. At this time, the jet thruster 61 is ejected out of the fixed frame 20 through the exhaust chamber 12, thereby pushing the jet propeller 61. The fixed frame 20 moves along the pipeline to the inside of the pipeline. When the fixed frame 20 moves, the pull wire 56 is pulled deeper into the interior of the pipeline. At this time, the second sliding rod 30 loses the abutment of the fixed frame 20. At this time, the first Under the action of the resetting device 299, the two sliding rods 30 move to the left and move out of the inclined hole 35. At this time, the third sliding rod 34 moves into the sliding cavity 36 under the action of the fourth spring 33. When the fixed frame 20 moves, the pulling wire 56 is straightened When the fixed frame 20 continues to move, the sliding block 62 moves to the left, and the sliding block 62 moves to the left to move the first rack 47 to the left, thereby driving the sliding block 62 to move to the right. Thus, the output shaft of the driving motor 49 is driven to move out of the spline hole 50, and the output shaft of the driving motor 49 continues to move right into the spline sleeve 45 and cooperates with the spline sleeve 45. The locking groove 37 is aligned with the third sliding hole 32, the third sliding rod 34 is inserted into the locking groove 37, and the pull wire 56 pulls the first sliding rod 18 out of the card slot 19, at this time The fan-shaped scraper 58 abuts against the pipe wall under the action of the third spring 59, at this time, the jet propeller 61 is closed, and the driving motor 49 is started to drive the spline sleeve 45 to rotate, thereby driving the The second bevel gear 43 rotates, thereby driving the first bevel gear 41 to rotate, thereby driving the reel 38 to rotate, thereby winding the pull wire 56 on the surface of the reel 38, thereby driving the fixing. The frame 20 approaches the fuselage 10, and the fan-shaped scraper 58 contaminates the inner wall of the pipe at this time. When scraping, the sludge is taken out along the pipeline. When the fixed frame 20 moves to abut with the second slide bar 30, the second slide bar 30 moves to the right to drive the third slide bar 34 out of the place. The reel 38 is described. At this time, the sliding block 62 is moved to the right under the action of the spline sleeve 45, so that the first rack 47 is moved to the right, so that the fixed block 63 is moved to the left, thereby driving the The output shaft of the driving motor 49 is splined to the spline hole 50 again, and the device returns to the initial state at this time.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. 1. A jet propulsion pipeline decontamination machine includes a fuselage and a fixing frame provided on the left side of the fuselage, and is characterized in that: the end wall of the fuselage is symmetrically distributed with a gear fixedly connected to the fuselage. A rod, four guide grooves with outward openings are symmetrically distributed in the center of the end wall of the fixed frame; left and right symmetrical moving blocks are slidably arranged in the guide sliding grooves; A threaded hole with a reverse thread is penetrated through, and the threaded hole is internally connected with a threaded rod. The moving block is hingedly connected to an end wall on the side wall away from the center of the fixed frame. The end is articulatedly connected with a support block slidingly arranged in the guide groove. The support block is provided with rotatable rollers symmetrically on the left and right sides of the support block. A rotating device provided in the right end wall of the guide groove drives the threaded rod. Rotation can drive the roller to move to the inner wall of the pipeline to be cleaned, thereby supporting the fixed frame in the pipeline, and the jet propeller provided in the fixed frame sprays the air through the exhaust cavity provided in the fixed frame. Out, The fixed frame is driven to move quickly in the pipeline. A sliding cavity is provided in the fuselage, and a sliding block is slidably disposed in the sliding cavity. The sliding block is disposed between the sliding block and the left end wall of the sliding cavity. There is a first spring, and a wire drawing device is provided in the sliding block, and the wire drawing device can rotate the winding wheel provided in the sliding block, thereby winding the drawing wire wound on the outer surface of the winding wheel, thereby pulling The fixed frame is moved out of the pipeline, and four fan-shaped grooves with outward openings are symmetrically distributed in the center of the end wall of the fixed frame. A scraping device is provided in the fan-shaped groove and the right end wall. The fixed frame drives the When the wire is straightened, the fan-shaped scraper provided in the scraping device is triggered to move out of the fan-shaped groove and connect to the inner wall of the pipe that needs to be decontaminated, so that when the wire pulling device drives the fixing frame to move out of the pipe, the inner wall of the pipe The sludge is scraped off. A leftward end wall of the sliding cavity is provided with a moving slot opening to the right, and a power device provided in the moving slot can drive the rotating device and the wire drawing device in a time-sharing manner.

2. The jet-propelled pipeline decontamination machine according to claim 1, wherein the rotating device comprises a rotating cavity provided in the fixing frame and an opening provided in a right end wall of the fixing frame to the right. A groove, the right end of the threaded rod extends into the rotation cavity and a first gear is fixedly disposed at the end, and a spline shaft is rotatably provided between the rotation cavity and the groove; A second gear meshing with the first gear is fixedly disposed at the end of the spline shaft.

3. The jet-propelled pipeline decontamination machine according to claim 1, wherein the wire drawing device comprises a transmission cavity provided in the sliding block, and four winding wires are symmetrically disposed in the center of the end wall of the transmission cavity. A first rotating shaft is rotatably provided between the transmission cavity and the winding cavity, and the end of the first rotating shaft in the winding cavity is fixedly connected with the reel, A first bevel gear is fixedly disposed at the end of the first rotation shaft, a second rotation shaft is rotatably disposed in the left end wall of the transmission cavity, and an end of the second rotation shaft in the transmission cavity is fixedly disposed with the first rotation shaft. A second bevel gear meshed with a bevel gear, a spline sleeve is fixedly arranged on the left side of the second rotating shaft through the left end wall of the sliding block and at the end.

4. The jet-propelled pipeline decontamination machine according to claim 3, wherein the scraping device comprises a first sliding hole opened to the left in an end wall on the right side of the fan-shaped groove, and the first A first sliding rod that cooperates with a slot provided in the right end wall of the fan-shaped scraper is slidably disposed in the sliding hole, and is disposed between the first sliding rod and the right end wall of the first sliding hole. A second spring, the end of one side of the pull wire far from the reel passes through the end of the fixing frame and is fixedly connected to the right end wall of the first sliding rod, and the fan-shaped scraper is disposed between the fan-shaped groove end wall There is a third spring.

5. The jet-propelled pipeline decontamination machine according to claim 3, wherein the power unit comprises a fixed block slidably arranged in the moving groove, and a driving motor is fixedly arranged in the fixed block, so that A guide sliding hole with an opening to the right is provided in the left end wall of the sliding cavity, and a first rack fixedly connected to the sliding block is slidably disposed in the guide sliding hole, and the guide sliding hole is in contact with the sliding guide hole. A gear cavity is provided in communication between the moving grooves, and a third gear meshing with the first rack and the second rack provided on the upper and lower end walls of the fixed block is rotatably provided in the gear cavity. A third rotating shaft is rotatably provided in the left end wall of the moving groove, and spline holes are symmetrically provided in the left and right end walls of the third rotating shaft. The left end of the output shaft of the drive motor extends into the right side. The spline hole in the spline is connected to the spline. The spline hole on the left is splined to the spline shaft. The left end wall of the fuselage is provided with a second sliding hole that opens to the left. A second sliding rod is slidably disposed in the second sliding hole, and the second sliding rod A reset device for driving the second slide rod to reset after the second slide rod is displaced is disposed between the second slide hole end wall, and a third slide opposite to the opening is symmetrically arranged in the upper and lower end walls of the slide cavity A third sliding rod is slidably disposed in the third sliding hole and cooperates with a locking groove provided symmetrically in the upper and lower end walls of the sliding block, and the third sliding rod and the third sliding hole end wall A fourth spring is provided between the three springs, and inclined holes penetrating left and right are provided in the third sliding rod.
